(19) United States
(12) Patent Application Publication
(10) Pub. No.: US 2009/0268925 A1
(43) Pub. Date: Oct. 29, 2009

(54) MICROPHONE ARRANGEMENT

(76) Inventor: Friedrich Reining, Vienna (AT)

Correspondence Address: HARMAN - BRINKS HOFER CHICAGO;Brinks Hofer Gilson & Lione, P.O. Box 10395, Chicago, IL, 60610, US

(21) Appl. No.: 12/391,004

(22) Filed: Feb. 23, 2009

(30) Foreign Application Priority Data
Nov. 13, 2007 (AT) PCT/AT2007/000510

(51) Int. Cl. H04R 3/00

(52) U.S. Cl. 381/92

(57) ABSTRACT

A microphone arrangement includes multiple pressure gradient transducers having a diaphragm, a first sound inlet opening, and a second sound inlet opening. A directional characteristic of each of the pressure gradient transducers have a direction of maximum sensitivity in main directions. The main directions of the pressure gradient transducers are inclined. A pressure transducer has an acoustic center lying within an imaginary sphere with multiple acoustic centers of the pressure gradient transducer. The imaginary sphere has a radius corresponding to about double the largest dimension of the diaphragms of the pressure gradient transducers and the pressure transducer.

### PRIORITY CLAIM

This application claims the benefit of priority from PCT/AT2007/000510, filed Nov. 13, 2007, which is incorporated by reference.

### BACKGROUND OF THE INVENTION

1. Technical Field

This disclosure relates to a microphone arrangement and more particularly to a microphone arrangement having a direction of maximum sensitivity in a main direction.

2. Related Art

One challenge in recording technology is minimizing the effect of feedback during live broadcasts and concerts. Feedback occurs when a signal transmitted from loudspeakers is received by microphones. Interference may mask or disturb broadcasts and concerts.

To avoid feedback signal paths between a source and a receiver may be lengthened. The use of directional microphones or arranging microphones in the acoustic shadows of loudspeakers may lengthen some sound paths. However, such arrangements may not fully prevent feedback.

Some transducers cannot distinguish between remote and near sound sources. This may prevent applications from receiving specific sound, while suppressing background noise, engine noise, vibrations, and/or other sounds. There is a need for systems that suppresses feedback while maintaining sensitivity to desired sound sources.

### SUMMARY

A microphone arrangement includes multiple pressure gradient transducers having a diaphragm, a first sound inlet opening, and a second sound inlet opening. A directional characteristic of each of the pressure gradient transducers have a direction of maximum sensitivity in main directions. The main directions of the pressure gradient transducers are inclined. A pressure transducer has an acoustic center lying within an imaginary sphere with multiple acoustic centers of the pressure gradient transducer. The imaginary sphere has a radius corresponding to about double the largest dimension of the diaphragms of the pressure gradient transducers and the pressure transducer.

Other systems, methods, features, and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 shows the transition between a far-field and a near-field as a function of distance and frequency.

FIG. 2 shows the sound velocity levels as a function of frequency for different distances from a sound source.

FIG. 3 shows a gradient transducer with sound inlet openings on opposite sides of a capsule housing.

FIG. 4 shows a gradient transducer with sound inlet openings on a common side of the capsule housing.

FIG. 5 shows a pressure transducer in cross-section.

FIG. 6 is a microphone arrangement in a plane.

FIG. 7 shows the pickup patterns of the individual transducers of FIG. 6.

FIG. 8 is a microphone arrangement supported by a curved surface.

FIG. 9 shows transducers in a common housing.

FIG. 10 is a transducer arrangement embedded in an interface.

FIG. 11 is a transducer arrangement arranged on the interface.

FIG. 12 is a microphone arrangement comprising gradient transducers and a pressure transducer.

FIG. 13 shows an arrangement that includes four gradient transducers and four pressure transducers.

FIG. 14 is a schematic of a coincidence condition.

FIG. 15 is signal processing logic of four transducers.

FIG. 16 is signal processing of five transducers,

FIG. 17 are pickup patterns of the signal obtained from the gradient transducers and the signal obtained from the pressure transducers, in which no sound is transmitted in the near-field.

FIG. 18 are the pickup patterns of the signal obtained from the gradient transducers and the signal obtained from the pressure transducer(s), in which a sound source emits in the near-field.

### DETAILED DESCRIPTION OF THE PREFERRED EMBODIMENTS

A microphone arrangement includes pressure gradient transducers and a pressure transducer. The acoustic centers of the pressure gradient transducers and the pressure transducer may lie within an imaginary sphere having a radius that corresponds to about double the largest dimension of the diaphragm of a transducer. In some systems, the acoustic centers of the pressure gradient transducers and the pressure transducer may lie within an imaginary sphere having a radius that corresponds to the largest dimension of the diaphragm of a transducer. Coincidence may increase by moving the sound inlet openings of the transducers together.

To generate the signals, the outputs of the pressure gradient transducers are summed and a signal having omni-directional characteristics is obtained from the pressure transducers. The signal output of the pressure transducers is subtracted from the summed output of the pressure gradient transducers.

Starting from at least three coincidentally arranged gradient transducers, an omni signal is generated. Additional omni signal may be produced by at least one pressure transducer arranged coincident to the gradient transducers. By different formations of the two omni signals that may be obtained in many ways, a difference signal is obtained. The intensity may depend on the near-field effect. The output reproduces sound sources that are situated in the vicinity of the microphone arrangement. Sound sources more distant from the microphone arrangement are represented increasingly more weakly in the difference signal.

The system exploits a near-field effect or proximity effect that may occur in radiant transducers. The event may increase low frequency output, if a sound source is positioned in the vicinity of the gradient transducer. Overemphasis of low frequencies may become stronger, the closer the sound source and gradient transducers become. The near-field effect may set in at a microphone spacing that is smaller than the wavelength λ of the considered frequency. In pressure transducers that are about equally sensitive in all directions and produce an omni signal, there may be no near-field effect. When both sides of a diaphragm in gradient transducers are connected acoustically to the surroundings by an opening, a pressure transducer may have only a sound inlet opening for the front of the diaphragm. In some pressure transducers, a tiny opening may pass through a capsule housing to compensate for static pressure changes. This configuration may have an effect on the properties or omni characteristics of a pressure transducer.

The near-field effect may only occur in pressure gradient transducers, (e.g., directed microphones). It may not occur in pressure transducers, and may be dependent on the angle of incidence of the sound, with reference to a main direction of the sound receiver. In the main direction of a cardioid or hypercardioid, the near-field effect may be strongly pronounced. It may be negligible in directions sloped by about 90° to it. To determine the distance between the coincident transducer arrangement and a sound source or as a criterion for sound sources to be picked up or masked out, the near-field effect is used. Since the omni signal obtained from the pressure transducer or from several pressure transducers (e.g., in combination) may not be influenced by a proximity effect, comparison between the gradient signal and the omni signal permits determination of the distance to the sound source. Depending on the quality of the individual transducers or their equivalence, the frequency responses of the signals obtained from the individual transducers may be adjusted by one or more of filters.

The signals derived from the transducer may generate an omni signal in different ways. A first omni signal may be generated when the gradient signals of three gradient transducers are summed. A second omni signal may be obtained from the pressure transducer (e.g., also called a zero-order transducer or a combination of transducers), which has an omni-directional pickup pattern. In alternative systems a second omni signal is generated from an arrangement of two or more pressure transducers. By summing several coincidentally arranged pressure transducers, (e.g., four or more), the resulting omni signal may approach an ideal sphere. In these systems, slight deviations from an omni signal in a single pressure transducer may be compensated by combining the output of several pressure transducers.

The summed signals or omni signals may not be uniform. Deviations may be caused by real signal transducers or transducers with pickup patterns or frequency responses deviating from each other, due to manufacturing variances. The omni signals may proximate a sphere. In some systems, deviations may occur due to the near-field effect in the signal produced with the gradient transducers. The sphere may contain a protruding part or a bulge in one direction. During difference formation, this bulge or outward curve remains and forms the desired (directed) signal.

Logically (e.g., encoded in software stored on a computer readable storage media), the near-field effect may be explained by differences in the transducer concept. In a flat sound field, the sound pressure and sound are always in phase, so that there is one near-field effect for a flat sound field. In a spherical sound source, a distinction is made between sound pressure and sound velocity. The amplitude of the sound pressure diminishes in a spherical sound source with 1/r (in which r denotes the distance from the omni sound source), so that in a pressure transducer (or a zero-order transducer), no near-field effect may occur. The sound velocity of the omni sound source is obtained from two terms:

$$\begin{matrix}{v}_{r , Far - field} = \frac{1}{ρ * c} * \frac{A}{r} cos [ k ( ct - r ) + {ϕ}_{A} ] & ( 1 ) \\ {V}_{r , Near - field} = \frac{1}{ρ * c} * \frac{A}{{kr}^{2}} sin [ k ( ct - r ) + {ϕ}_{A} ] & ( 2 )\end{matrix}$$

In which:

### ρ . . . Density

r . . . Distance from the sound source
c . . . Sound velocity

### λ . . . Wavelength

### t . . . Time

### φ_{A} . . . Phase

k . . . Circular wave number (2π/λ or 2πf/c)

### A . . . Amplitude

### f . . . Frequency

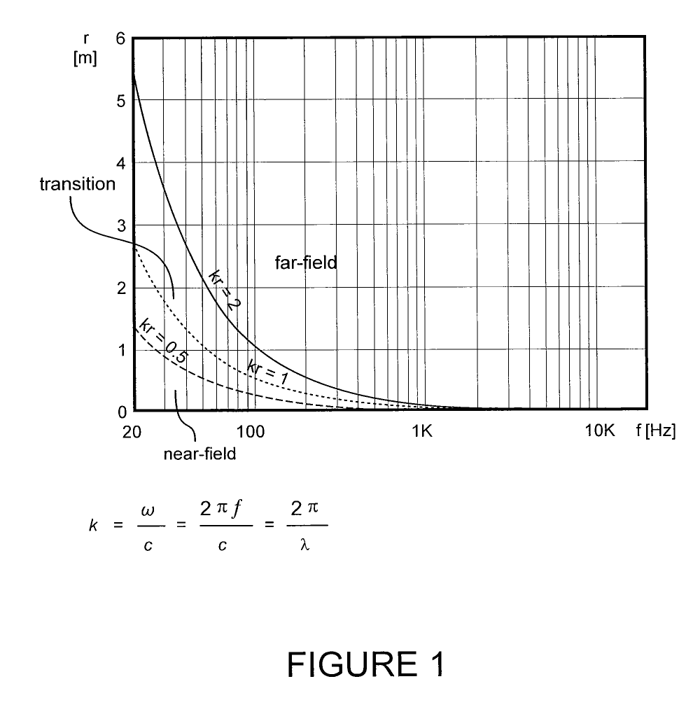

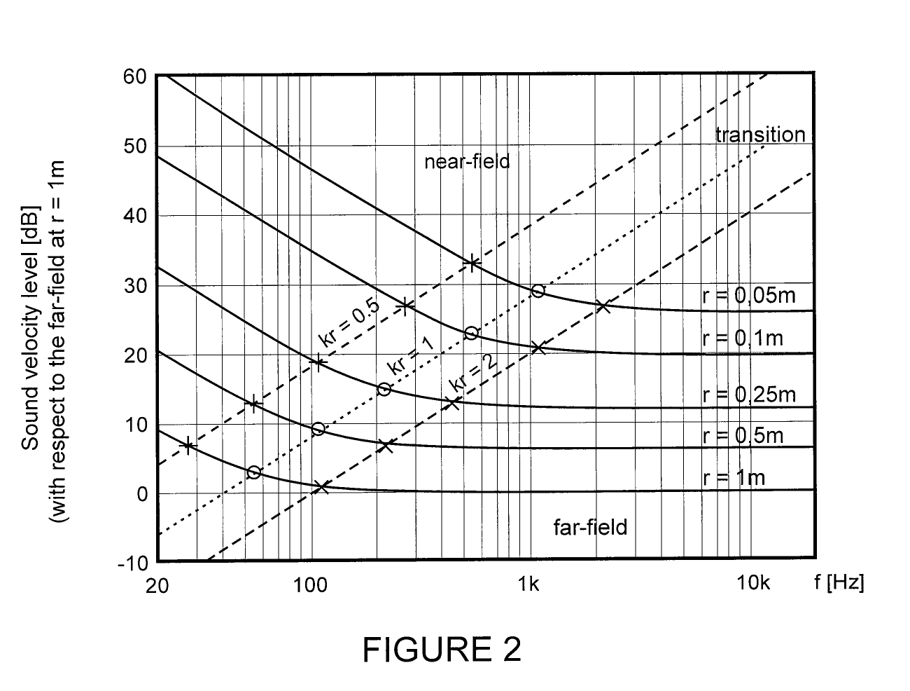

In formulas (1) and (2), the sound velocity diminishes in the far-field of 1/r, but in the near-field with 1/(k×r²). The increase of signal level pickup with a pressure gradient microphone as a function of distance and frequency is shown in FIGS. 1 and 2. The separation between the near and far-field is described by k×r=1, the transitional areas between the near and far-field are limited by k×r=2 and k×r=0.5.

The characteristics of each individual gradient capsule may also be described by the formula:

$$K = \frac{1}{a + b} ( a + b cos ( θ ) ) \qquad ( 1 )$$

in which α represents the weighting factor of the omni fraction and b the weighting factor for the gradient fraction. For values a=1, b=1, a cardioid may be obtained, for values a=1 and b=3, a hypercardioid may be obtained.

The boost factor B of a gradient microphone may be described by the proximity effect as a function of angle of incidence on the gradient microphone. This relationship described in “On the Theory of the Second-Order Sound Field Microphone” by Philip S. Cotterell, BSc, MSc, AMIEE, Department of Cybernetics, February 2002, which is incorporated by reference, is:

$$B = \frac{1}{a + b} \frac{\sqrt{{b}^{2} {cos}^{2} ( θ ) {cos}^{2} ( Φ ) + {k}^{2} {{r}^{2} ( a + b cos ( θ ) cos ( Φ ) )}^{2}}}{kr} \qquad ( 3 )$$

The angle θ may stand for the azimuth of the omni coordinates and φ for the elevation. For the simple case of a cardioid (a=1, b=1), the boost factor B at large values of (k×r), (e.g., at large distance r and high frequency f), may comprise

$$B = \frac{1}{2} \frac{\sqrt{1 + 4 {k}^{2} {r}^{2}}}{kr} \qquad ( 4 )$$

This expression tends toward the value 1 for increasing (k×r).

At small values of (k×r), the following expression may be obtained for the boost factor B

$$B = \frac{1}{2 kr} \qquad ( 5 )$$

Smaller values of (k×r) lead to a successive increase in level.

If an azimuthal angle θ of 180° is inserted in formula (3), the same expression as in formula (5) may be obtained for the boost factor B. This means that the near-field effect has a type of figure-eight characteristic (for an azimuthal angle θ of 90°, the dependence on k×r disappears).

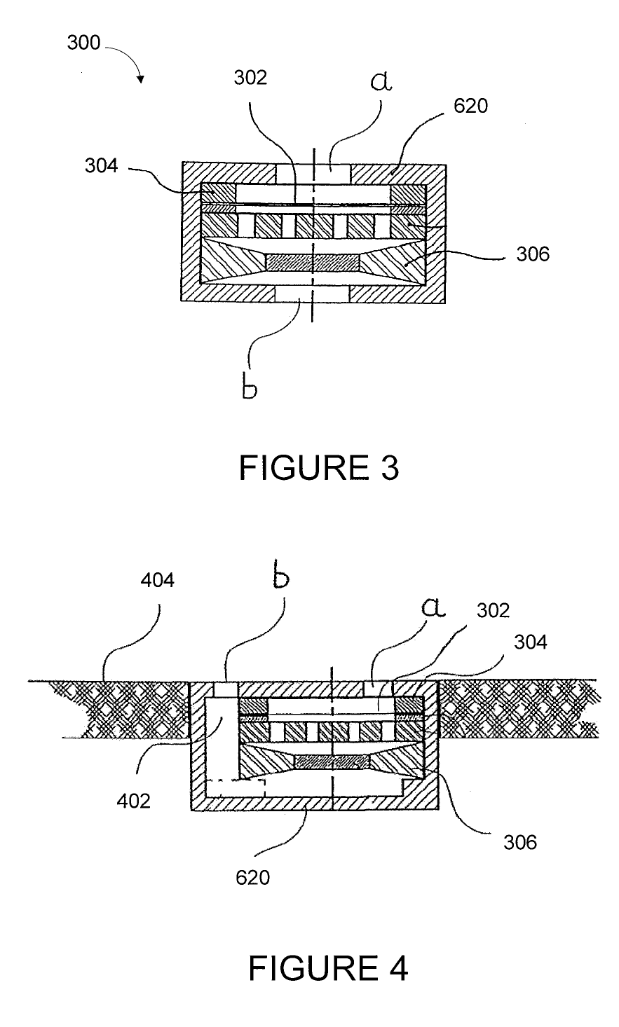

Examples of transducer arrangements are further shown in FIGS. 3 to 5. FIG. 3 and FIG. 4 show the difference between a “normal” gradient capsule and a “flat” gradient capsule. In the former, shown in FIG. 3, a sound inlet opening a is situated on the front of the capsule housing 300 and a second sound inlet opening b on the opposite back side of capsule housing 300. The front sound inlet opening a is connected to the front of diaphragm 302, which is tightened on a diaphragm ring 304, and the back sound inlet opening b is connected to the back of diaphragm 302.

For pressure gradients, it applies that the front of the diaphragm is the side that may be reached relatively unhampered by the sound. The back of the diaphragm may be reached (e.g., only reached) by the sound after it passes through an acoustically phase-rotating element. The sound path to the front is shorter than the sound path to the back and the sound path to the back has high acoustic friction. In the area behind electrode 7 or where the acoustic friction device 8 is situated the acoustic friction may form a constriction from a non-woven element, foam element, or other material.

In the flat gradient capsule of FIG. 4, (or interface microphone) both sound inlet openings a, and b are positioned on the front of capsule housing 300. One inlet leads to the front of the diaphragm 302 and the other to the back of diaphragm 302 through a sound channel 402. This converter may be incorporated in an interface 404, for example, within a console of a vehicle, etc. The acoustic friction devices 306 or non-woven devices, foam, constrictions, perforated devices, plates, etc., may be arranged in the area next to diaphragm 302. A very flat (or substantially flat) design may be used.

In arrangements with sound inlet openings a and b positioned on one side of a capsule, an asymmetric pickup pattern relative to the diaphragm axis may occur. Cardioid, hypercardioid, etc. patterns may occur. Other patterns including those described in EP 1 351 549 A2 or U.S. Pat. No. 6,885,751 A, which are incorporated by reference, may be generated.

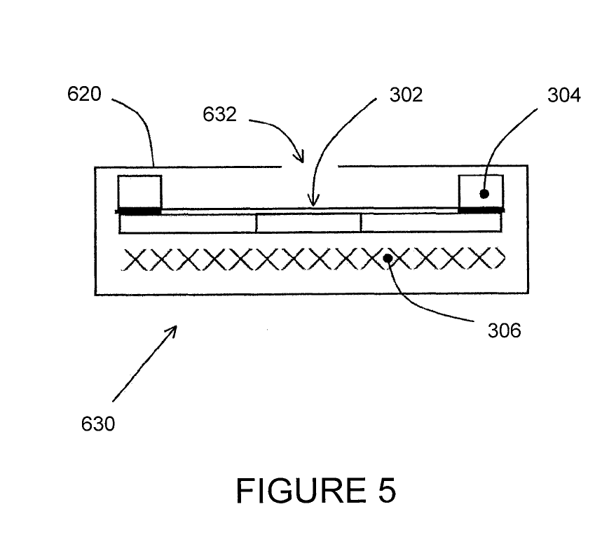

A pressure transducer, or zero-order transducer, is shown in FIG. 5. In this figure, only the front of the diaphragm is directly exposed to the surroundings. The back faces a closed volume. In some arrangements, small openings pass into the rear volume, to compensate for static pressure changes. In this alternative, passages to the volume have little or no effect on the dynamic properties and pickup pattern. Pressure transducers may have an omni pickup pattern. Slight deviations may occur with changes in frequency.

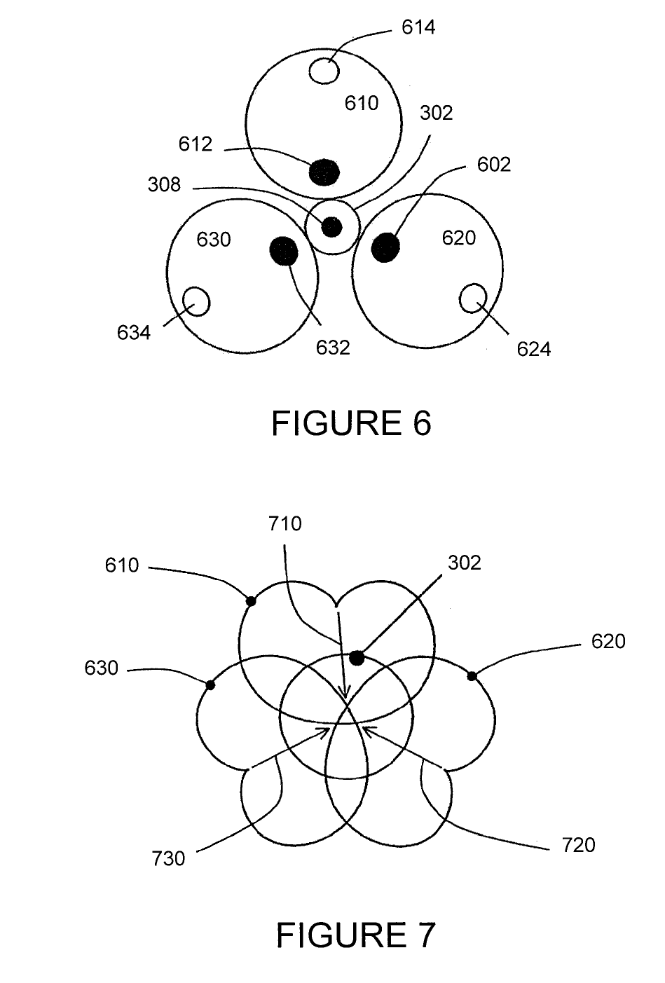

FIG. 6 shows a microphone arrangement that includes three pressure gradient transducers 610, 620, 630 and a pressure transducer 302 enclosed by the pressure gradient transducers. The pickup pattern of the pressure gradient transducers of FIG. 7 includes an omni portion and a figure-eight portion. This pickup pattern may be represented as P(θ)=k+(1−k)×cos(θ), in which k denotes the angle-independent omni fraction and (1−k)×cos(θ) the angle-dependent figure-eight portion. An alternative mathematical description of the pickup pattern, which also accounts for normalization, is described by equation (1). As shown in the directional distribution of the individual transducers of FIG. 7, the gradient transducer may be positioned to generate a cardioid characteristic. In alternative arrangements, gradients may result in a combination of sphere and figure-eight like shapes (e.g., like hypercardioids).

The pickup pattern of a pressure transducer 302 may comprise an omni. Deviations from an omni form may occur at higher frequencies due to tolerances and quality variations. The pick-up pattern may also be described approximately by a sphere like shape. Unlike a gradient transducer, a pressure transducer may have one sound inlet opening. The deflection of the diaphragm may be proportional to pressure and not dependent on a pressure gradient between the front and back of the diaphragm.

The gradient transducers 610, 620, and 630 may lie in an x-y plane and may be distributed almost uniformly about the periphery of an imaginary circle, (e.g., they may have essentially the same spacing relative to each other). In a three gradient transducer arrangement, the main directions 710, 720, 730 (the directions of maximum sensitivity) may be sloped relative to each other by an azimuthal angle of about 120° (FIG. 7). In n gradient transducers, the angle between main directions lying in a plane is 360°/n. Deviations of a few degrees may occur.

Any type of gradient transducer may be used in the disclosed arrangements. The illustrated arrangements provide good performance through a flat transducer or interface microphone, in which the two sound inlet openings lie on a common side surface or interface.

In FIG. 6, the converters 610, 620, 630, 302 are arranged in coincidence with each other. The converters oriented relative to each other, so that the sound inlet openings 612, 622, 632, 308, which lead to the front of the corresponding diaphragm, lie as close as possible to each other. The sound inlet opening 614, 624, 634 of the gradient transducers, which lead to the back of the diaphragm, lie on the periphery of the arrangement. The intersection of the lengthened connection lines, which connect the front sound inlet opening 612, 622, 632 to the rear sound inlet opening 614,624, 634 may be viewed as the center of the microphone arrangement. The pressure transducer 302 lies near or in the center of this arrangement. FIG. 7, shows the center in which the main directions 710, 720, 730 of the gradient transducers are directed. The front sound inlet openings 612, 622, 632 of the transducers 610, 620 and 630, also called speak-ins, are positioned in the center area of the arrangement. Through this arrangement, coincidence of the converters may be strongly increased. The pressure transducer 302 is situated in a center area of the microphone arrangement. The single sound inlet opening of pressure transducer 302 may be positioned at the intersection of the connection lines of the sound inlet openings of the pressure gradient transducers 610, 620, 630.

Coincidence may occur because the acoustic centers of the gradient transducers 610, 620, 630 and the pressure transducer 302 lie together as close as possible, preferably at a common point or area. The acoustic center of a reciprocal transducer occurs at the point from which omni waves seem to be diverging when the transducer is acting as a source. “A note on the concept of acoustic center”, by Jacobsen, Finn; Barrera Figueroa, Salvador; Rasmussen, Knud; Acoustical Society of America Journal, Volume 115, Issue 4, pp. 1468-1473 (2004), which is incorporated by references, examines methods of determining the acoustic center of a source, including methods based on deviations from the inverse distance law and methods based on the phase response. The considerations are illustrated by experimental results for condenser microphones.

The acoustic center may be determined by measuring omni wave fronts during sinusoidal excitation of the acoustic transducer. The measurement may occur at a selected frequency at a selected direction and at a selected distance from the converter in a small spatial area, the observation point. Starting from the information about the omni wave fronts, information may be gathered about the center of the omni wave, the acoustic center.

“The acoustic center of laboratory standard microphones” by Salvador Barrera-Figueroa and Knud Rasmussen; The Journal of the Acoustical Society of America, Volume 120, Issue 5, pp. 2668-2675 (2006), which is incorporated by reference, provides information about acoustic centers. For a reciprocal transducer, like the condenser microphone, it may not matter whether the transducer is operated as a sound transmitter or a sound receiver. The acoustic center may be determined by the inverse distance law:

$$p ( r ) = j \frac{ρ * f}{2 * {r}_{t}} {M}_{f} * i * {e}^{- γ * {r}_{1}} \qquad ( 6 )$$

rₜ . . . acoustic center
ρ . . . density of the air
f . . . frequency
M_{f} . . . microphone sensitivity
i . . . current
y . . . complex wave propagation coefficient

In pressure receivers, the center may comprise average frequencies (in the range of 1 kHz) that may deviate at high frequencies. The acoustic center may occur in a small region. The acoustic center of gradient transducers may be identified by a different approach, since formula (6) does not consider near-field-specific dependences. The location of an acoustic center may also be identified by locating the point in which a transducer must be rotated, in order to observe the same phase of the wave front at the observation point.

In the gradient transducer, an acoustic center may be identified through a rotational symmetry. The acoustic center may be situated on a line normal (or substantially normal) to the plane of the diaphragm. The center point on any line may be determined by two measurements, at a point most favorable from the main direction of about 0°, and from a point of about 180°. In addition to comparisons of phase responses of these two measurements, which determine a frequency-dependent acoustic center, an average estimate of the acoustic center may change the rotation point. The rotation point is the point around which the transducer is rotated between the measurement, so that the impulse responses maximally overlap (e.g., so that the maximum correlation between the two impulse responses lies in the center).

In “flat” gradient capsules, in which two sound inlet openings are positioned on an interface, the acoustic center may not be the center of the diaphragm. The acoustic center may lie closest to the sound inlet opening that leads to the front of the diaphragm. This forms the shortest connection between the interface and the diaphragm. In other arrangements, the acoustic center lies outside the capsule.

When using an additional pressure transducer, separation should be considered. If one considers the diaphragm of a pressure transducer in the XY plane and designates the angle that an arbitrary in the XY plane encloses with the X axis as azimuth, and the angle that an arbitrary direction encloses the XY plane as an elevation, the following may be practiced. The deviation of the pressure transducer signal from the ideal omni signal may become greater with increasing frequency (for example, above 1 kHz), but increases much more strongly during sound exposure from different elevations.

Because of these considerations, an alternative is obtained when the pressure transducer is arranged on an interface, so that the diaphragm is substantially parallel to the interface. In an alternative, the diaphragm lies as close as possible to the interface, preferably flush with it, but at least within a distance that corresponds to the maximum dimension of the diaphragm. The acoustic center for such a layout lies on a line substantially normal to the diaphragm surface at or near the center of the diaphragm. With good approximation, the acoustic center may lie on the diaphragm surface in the center of the diaphragm.

The coincidence criterion may require, that the acoustic centers 1410, 1420, 1430, 1402 of the pressure gradient capsules 610, 620, 630 and the pressure transducer 302 lie within an imaginary sphere O, whose radius R is double (or about double) the largest dimension D of the diaphragm of a transducer. In an alternative system the acoustic centers of the pressure gradient transducers and the pressure transducer may lie within an imaginary sphere whose radius corresponds to the largest dimension of the diaphragm of a transducer. By increasing the coincidence by moving the sound inlet openings together, exceptional results may be achieved.

To ensure a coincidence condition in one exemplary arrangement, the acoustic centers 1410, 1420, 1430, 1402 of the pressure gradient capsules 610, 620, 630 and the pressure transducer 302 lie within an imaginary sphere O, having a radius R equal to the largest dimension D of the diaphragm of a transducer. The size and position of the diaphragms 1412, 1422, 1432, 1404, are indicated by dashed lines.

In an alternative, the coincidence condition may also be established, in that the first sound inlet openings 612, 622, 632 and the sound inlet opening 308 for pressure transducer 302 lie within an imaginary sphere O, whose radius R corresponds to the largest dimension D in diaphragm 1402, 1422, 1432, 1404 of the transducer. Since the size of the diaphragm may determine the noise distance and may represent the direct criterion for acoustic geometry, the largest diaphragm dimension D (for example, the diameter in a circular diaphragm, or a side length in a triangular or rectangular diaphragm) may determine the coincidence condition.

In some systems the diaphragms 1402, 1422, 1432, and 1404 do not have the same dimensions. In these systems, the largest diaphragm is used to determine the preferred criterion.

In FIG. 6, the transducers 610, 620, 630 and 302 are positioned in a plane. The connection lines of the individual transducers, which connect the front and rear sound inlet opening to each other, are sloped relative to each other by an angle of about 120°.

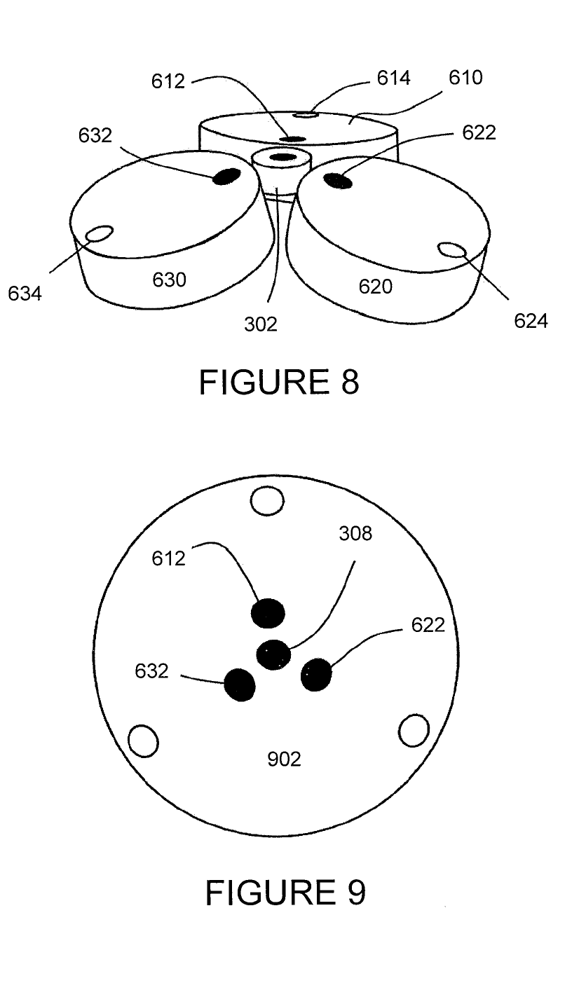

FIG. 8 shows two pressure gradient transducers 610, 620, 630 and the pressure transducer 302 are not arranged in a plane, but positioned on an imaginary omni surface. This may occur when the sound inlet openings of the microphone arrangement are arranged on a curved interface, for example, like a console of a vehicle. The interface, in which the transducers are embedded, or on which they are fastened, is not shown in FIG. 8.

In the curvature arrangement of FIG. 8, the distance to the center may be reduced (which is desirable, because the acoustic centers lie closer together), but the speak-in openings are somewhat shadowed. This may change the pickup pattern of the individual capsules, so that the figure-eight fraction of the signal becomes smaller (from a hypercardioid, a cardioid is then formed). To minimize the adverse affect of the curvature may be limited (e.g., not to exceed about 60°). The pressure gradient capsules 610, 620, 630 are placed on the outer surface of an imaginary cone, whose surface line encloses an angle of at least 30° with the cone axis.

The sound inlet openings 612, 622, 632 of the gradient transducers that lead to the front of the diaphragm lie in a plane, referred to as the base plane. The sound inlet openings 614, 624, 634 arranged on a curved interface lie outside of the base plane. The projections of the main directions of the gradient transducers 610, 620, 630 into the base plane enclose an angle that amounts to about 360°/n, in which n stands for the number of gradient transducers arranged in a circle.

Like the arrangement where the capsules are arranged in a plane, the main directions of the pressure gradient transducers are sloped relative to each other by an azimuthal angle φ (e.g., they are not only sloped relative to each other in a plane of the cone axis, but the projections of the main directions are sloped relative to each other in a plane normal to the cone axis).

In the arrangement of FIG. 8, the acoustic centers of the gradient transducers 610, 620, 630 and the pressure transducer 302 also lie within an imaginary sphere, whose radius is less than the largest dimension of the diaphragm of a transducer in the arrangement. By this spatial proximity of acoustic centers, coincidence is achieved. Like the alternative system of FIG. 6, the capsules depicted in FIG. 8 are arranged on an interface or embedded within it.

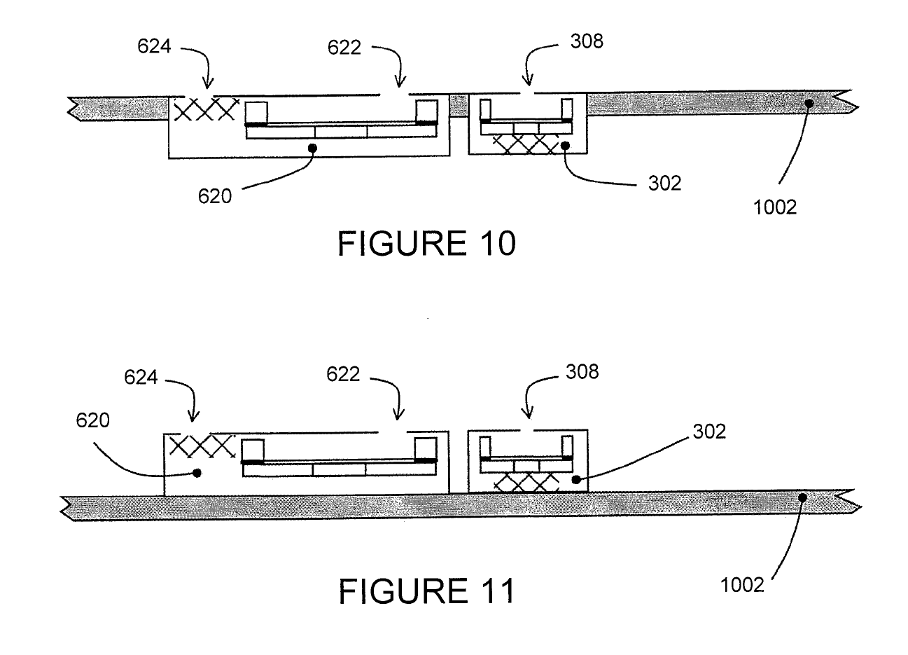

Capsule arrangements on an interface are shown in FIGS. 10 and 11. In FIG. 10, which shows a section through a microphone arrangement from FIG. 6, the capsules positioned on the interface 1002 or are fastened to it. In FIG. 11, they are embedded in interface 1002 and are flush with interface 1002 with their front sides.

In an alternative system, the pressure gradient capsules 610, 620, 630 and the pressure transducer 302 are arranged within a common housing 902, in which the diaphragms, electrodes and mounts of the individual transducers are separated from each other by partitions. The sound inlet openings may not be visible from an outside view in some systems. The surface of the common housing, in which the sound inlet openings are arranged, may be a plane (refer to the arrangement of FIG. 6) or a curved surface (refer to the arrangement of FIG. 8). The interface 20 may be a plate, console, wall, cladding, etc.

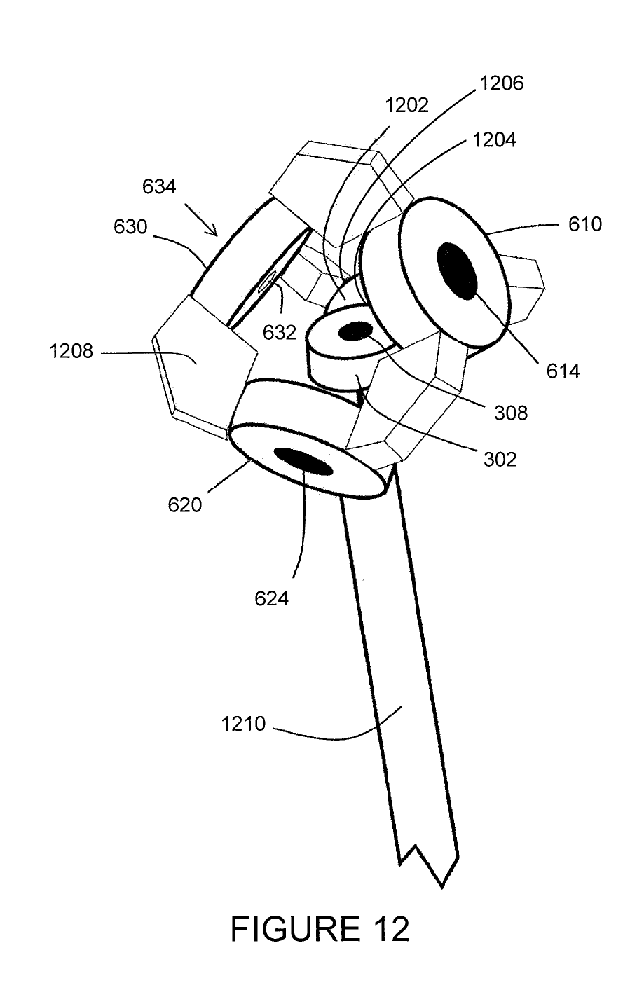

FIG. 12 shows an alternative that does not include a one-sided sound inlet microphone. In the alternate, four gradient transducers are used in spatial arrangement. In each of the pressure gradient transducers 610, 620, 630, 1202, the first sound inlet opening 612, 622, 632, 1204 is arranged on the front of the capsule housing, the second sound inlet opening 614, 624, 634, 1206 on the back of the capsule housing. The pressure transducer 302 has only sound inlet opening 308 passing through a front surface. The first sound inlet openings 612, 622, 632, 1204, lead to the front of the diaphragm and face each other. This arrangement satisfies coincidence criterion in that they lie within an imaginary sphere, whose radius corresponds to double of the largest dimension of the diaphragm in one of the transducers. The main directions of the gradient transducers face a common center area of the microphone arrangement.

Exemplary dimensions are shown in FIG. 12. Assume the spatial transducer arrangement comprises ideal flat transducers that coincide with the surface of a tetrahedron. A ratio is obtained from the maximum diameter D of the diaphragm surface to the radius R of the enclosing sphere:

$${R}_{Sphere} = {D}_{Membrane} * \frac{3}{4} \sqrt{2 •1 .06}$$

In some configurations, such a transducer arrangement may not be implemented with diaphragms extending to the edges of the tetrahedron, since the diaphragms may be mounted on a rigid ring and the individual capsules may not be made arbitrarily thin. However this issue may be overcome, if the transducer arrangement, particularly the sound inlet openings leading to the front of the diaphragm, lies within an imaginary sphere O, whose radius R is equal to double (or about double) the largest dimension D of the diaphragm of one of the transducers.

If, the gradient transducers, shown in FIG. 12, are arranged on the surfaces of an imaginary tetrahedron and are spaced from each other by spacers 1208, this arrangement creates space for the pressure transducer 302 in the center of the arrangement. The entire arrangement may be secured to a microphone rod or support 1210.

In FIG. 10, the coincident condition may appear to arrangements with four pressure gradient transducers or more. Four or more gradient transducers may be arranged to obtain a synthesized omni signal from their signals by sum formation.

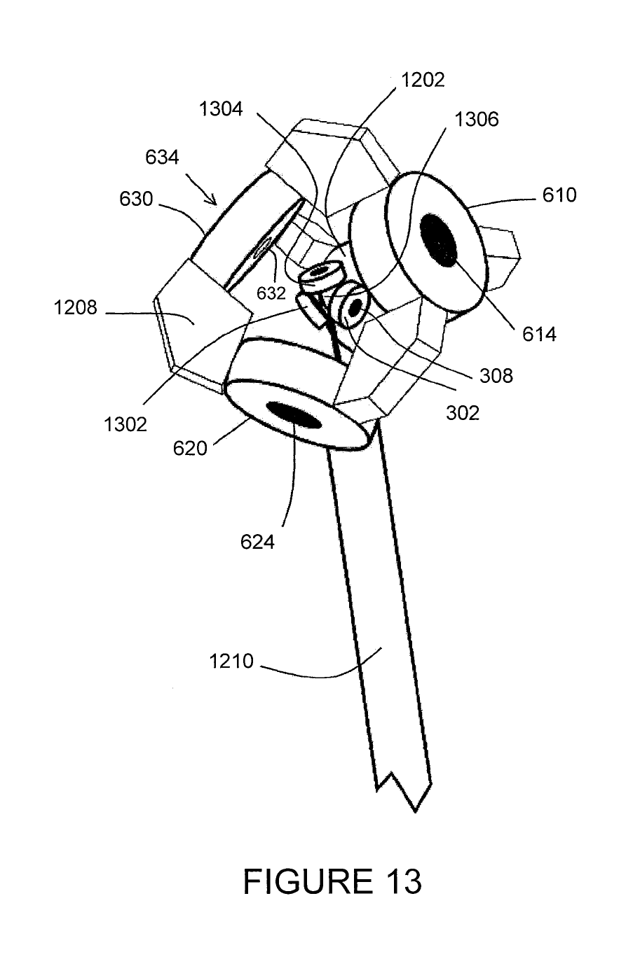

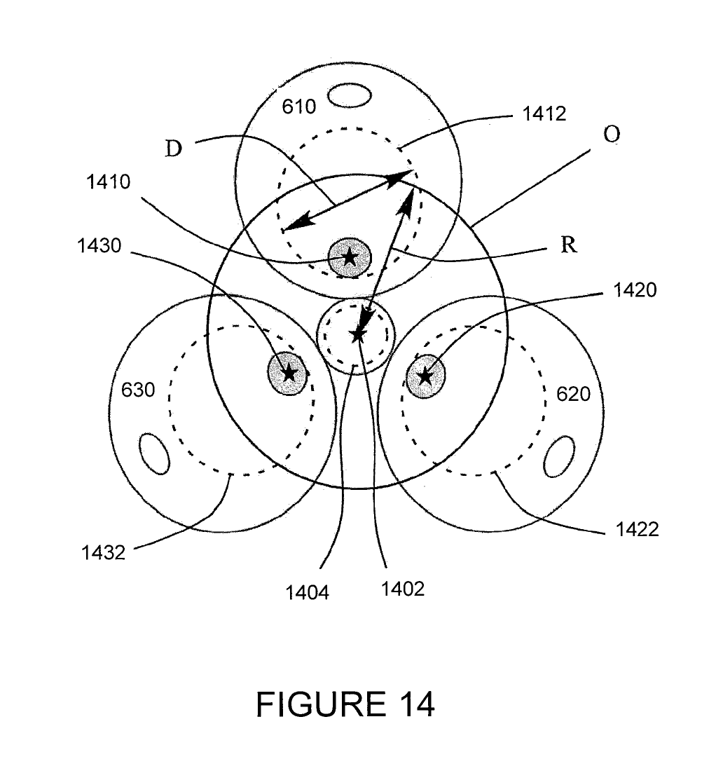

In FIG. 13, several pressure transducers 302, 1302, 1304, 1306 may also be positioned in an alternative system. By summation of the omni signals of the individual pressure transducers, a omni signal is formed that is still homogeneous in its approximation to an ideal sphere and is independent of frequency. In the present practical example, four pressure transducers 302, 1302-1306 are arranged on the surface of the tetrahedron. The sound inlet openings are directed outward. The spacers 1208 may be used to position the pressure transducers or gradient transducers.

FIG. 11 shows the logic (e.g., stored on a computer readable medium executable by a processor) or circuit the pressure gradient transducers and pressure transducers. In some systems, the synthesis is executed by a signal processor. The output pressure gradient transducers 610, 620, 630, and optionally 1204, are converted by analog/digital converters and adapted to each other by means of filters F1, F2, F3, and optionally F4. These filters may compensate for tolerances, slightly deviating frequency responses, etc. and are calibrated before startup, so that the transmission function of each signal is substantially the same. The gradient signals are summed and produce the sum signal S_{gradient}. Since this sum signal consists of individual gradient signals, the near-field effect affects the sum signal, so that deviation of the sum signal from the ideal omni shape occurs as a function of distance of the sound source to the microphone arrangement.

The output signal of the pressure transducer 1302 is digitized and processed, and optionally amplified with amplifier 1602 (e.g., through a parallel processing). During pickup in the far-field, in which the sum signal S_{gradient} has at least roughly an omni shape, (e.g., because no near-field effect causes distortion of the omni shape), the sum signal S_{gradient} and the output signal of the amplifier Sₚᵣₑₛₛᵤᵣₑ should be substantially equal, if possible. This state minimizes difference formation at the output, (in the ideal case, no signal S_{diff} forms at all).

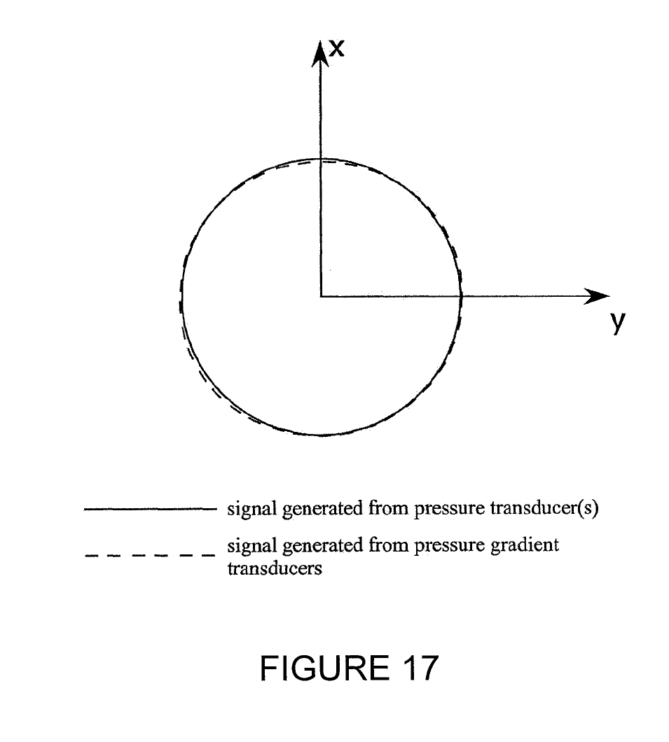

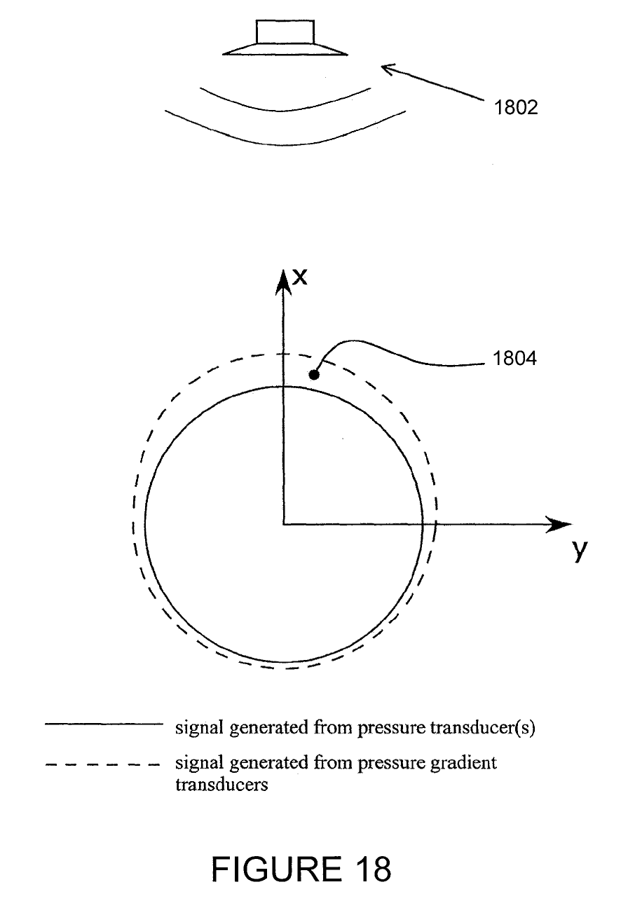

FIGS. 17 and 18 show the pickup patterns of the sum signal S_{gradient} obtained from the individual gradient signals (dashed line) and the sum signal Sₚᵣₑₛₛᵤᵣₑ obtained from the pressure transducer(s) (solid line). When sound exposure occurs from a sufficient distance, (e.g., the sound sources are positioned in the far-field). Both signals S_{gradient} and Sₚᵣₑₛₛᵤᵣₑ are essentially omni and cover each other—after corresponding normalization (FIG. 17).

When a sound source 1802 is arranged in the near-field and transmits sound, the pickup pattern of the sum signal S_{gradient} obtained from the individual gradient signals changes (dashed line). A bulge 1804 in the direction toward the sound source occurs, since the near-field effect now shows its effect.

Based on the flat microphone arrangement from FIG. 6, FIG. 18 may be explained. The gradient transducers are oriented, so that the main direction of one of the gradient transducers points in the x-direction (coordinate system in FIG. 18) and is therefore directed toward the sound source. The main directions of the two other gradient transducers are (according to FIG. 6) sloped downward by about 120°. This explains why the bulge in direction +x is about twice as large as in direction −x. The sum of the two other gradient transducers, as a result of the proximity effect, gives a level difference of about −6 B to the front gradient transducer. The reason for this lies in the fact that the two gradient transducers, whose main directions face away from the sound source, have much lower sensitivity in the x-direction.

The bulge 1804, which remains after difference formation S_{gradient}−Sₚᵣₑₛₛᵤᵣₑ, now points precisely in the direction, from which the sound reaches the microphone arrangement, so that, to a certain extent, a directed pickup and determination of the distance becomes possible. Determination of distance occurs by interpreting the amplitude and comparison with stored test data. The transducer arrangement may be measured from different directions and distances and the ratio of S_{gradient} to Sₚᵣₑₛₛᵤᵣₑ may be stored in a memory.

Other alternate systems and methods may include combinations of some or all of the structure and functions described above or shown in one or more or each of the figures. These systems or methods are formed from any combination of structure and function described or illustrated within the figures. Some alternative systems or devices compliant with one or more of the transceiver protocols may communicate with one or more in-vehicle or out of vehicle receivers, devices or displays.

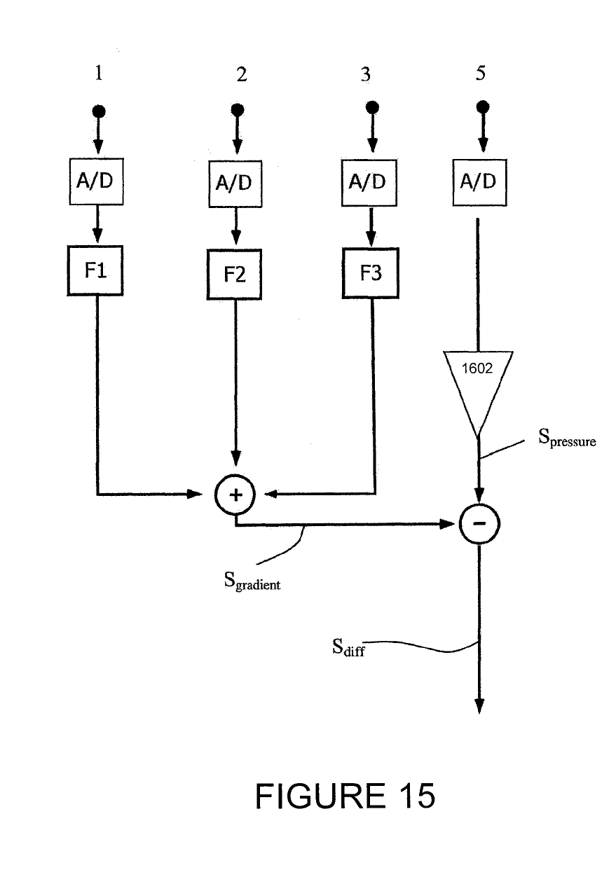

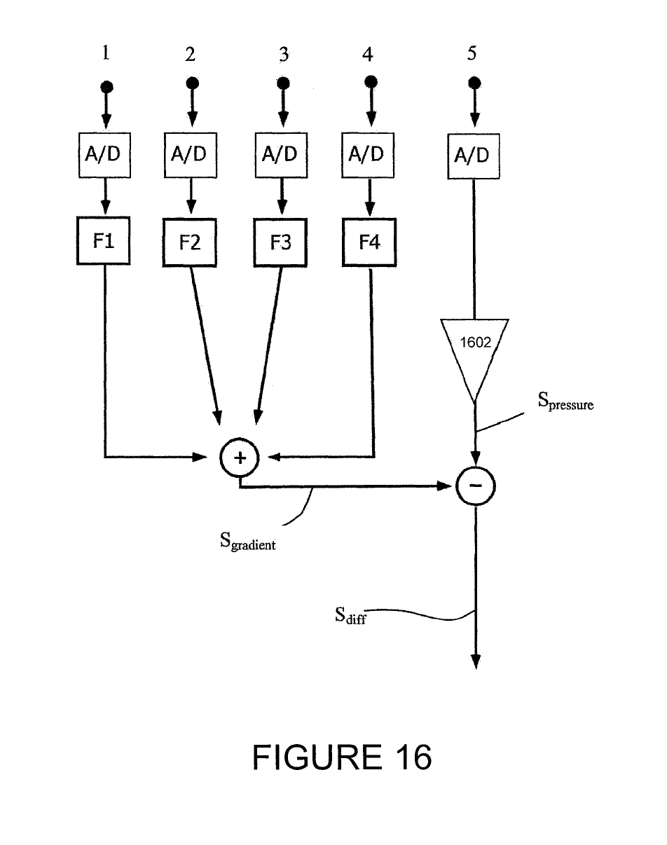

The methods and descriptions of FIGS. 1, 2, 15, and 16 may be programmed in one or more controllers, devices, processors (e.g., signal processors). The processors may comprise one or more central processing units that supervise the sequence of micro-operations that execute the instruction code and data coming from memory (e.g., computer memory) that generate, support, and/or complete a compression or signal modifications. The dedicated applications may support and define the functions of the special purpose processor or general purpose processor that is customized by instruction code (and in some applications may be resident to vehicles). In some systems, a front-end processor may perform the complementary tasks of gathering data for a processor or program to work with, and for making the data and results available to other processors, controllers, or devices.

The methods and descriptions may also be programmed between one or more signal processors or may be encoded in a signal bearing storage medium a computer-readable medium, or may comprise logic stored in a memory that may be accessible through an interface and is executable by one or more processors. Some signal-bearing storage medium or computer-readable medium comprise a memory that is unitary or separate from a device, programmed within a device, such as one or more integrated circuits, or retained in memory and/or processed by a controller or a computer. If the descriptions or methods are performed by software, the software or logic may reside in a memory resident to or interfaced to one or more processors or controllers that may support a tangible or visual communication interface, wireless communication interface, or a wireless system.

The memory may include an ordered listing of executable instructions for implementing logical functions. A logical function may be implemented through digital circuitry, through source code, or through analog circuitry. The software may be embodied in any computer-readable medium or signal-bearing medium, for use by, or in connection with, an instruction executable system, apparatus, and device, resident to system that may maintain persistent or non-persistent connections. Such a system may include a computer-based system, a processor-containing system, or another system that includes an input and output interface that may communicate with a publicly accessible distributed network through a wireless or tangible communication bus through a public and/or proprietary protocol.

A “computer-readable storage medium,” “machine-readable medium,” “propagated-signal” medium, and/or “signal-bearing medium” may comprise any medium that contains, stores, communicates, propagates, or transports software or data for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection having one or more wires, a portable magnetic or optical disk, a volatile memory, such as a Random Access Memory (RAM), a Read-Only Memory (ROM), an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A microphone arrangement comprising:
a plurality of pressure gradient transducers, each having a diaphragm, a first sound inlet opening leading to the front of the diaphragm, and a second sound inlet opening leading to the back of the diaphragm;
a directional characteristic of each of the plurality of pressure gradient transducer having a direction of maximum sensitivity in a plurality of main directions, and in which the plurality of main directions of the plurality of pressure gradient transducers are inclined relative to each other, and
a pressure transducer having an acoustic center lying within an imaginary sphere with a plurality of acoustic centers of the pressure gradient transducers, the imaginary sphere having a radius corresponding to double the largest dimension of the diaphragm of the plurality of pressure gradient transducer or the pressure transducer.

2. The microphone arrangement of claim 1 where each of the acoustic centers of the pressure gradient transducers and the pressure transducer lie within an imaginary sphere whose radius corresponds to the largest dimension of the diaphragm of at least one of the plurality of pressure gradient transducer or the pressure transducer.

3. The microphone arrangement of claim 2 where the plurality of pressure gradient transducers comprises three pressure gradient transducers and where at least one of the three pressure gradient transducers is positioned such that the projections of the plurality of main directions main directions of the three pressure gradient transducers that lie in a base plane that is spanned by the first sound inlet openings of the pressure gradient transducers enclose an angle of substantially 120°.

4. The microphone arrangement of claim 1 where the plurality of pressure gradient transducers comprises three pressure gradient transducers and where at least one of the three pressure gradient transducers is positioned such that the projections of the plurality of main directions main directions of the three pressure gradient transducers that lie in a base plane that is spanned by the first sound inlet openings of the pressure gradient transducers enclose an angle of substantially 120°.

5. The microphone arrangement of claim 4 where the plurality of pressure gradient transducers and the pressure transducer are arranged within a boundary.

6. The microphone arrangement of claims 5 where of each of the pressure gradient transducers, the first sound inlet opening and the second sound inlet opening are arranged on a same side of a transducer housing.

7. The microphone arrangement of claims 1 where of each of the pressure gradient transducers, the first sound inlet opening and the second sound inlet opening are arranged on a same side of a transducer housing.

8. The microphone arrangement of claim 5, where each of the front surfaces of each of plurality of the pressure gradient transducers and the pressure transducer are arranged flush with a boundary.

9. The microphone arrangement of claim 1, where each of the front surfaces of each of plurality of the pressure gradient transducers and the pressure transducer are arranged flush with a boundary.

10. The microphone arrangement of claim 9 where the plurality of pressure gradient transducers, each of the first sound inlet opening is arranged on the front side of a transducer housing and each of the second sound inlet opening is arranged on a back side of the transducer housing.

11. The microphone arrangement of claim 1 where the plurality of pressure gradient transducers, each of the first sound inlet opening is arranged on the front side of a transducer housing and each of the second sound inlet opening is arranged on a back side of the transducer housing.

12. The microphone arrangement according to claim 11 where the plurality of pressure gradient transducers and the pressure transducer are arranged in a common capsule housing.

13. The microphone arrangement according to claim 1 where the plurality of pressure gradient transducers and the pressure transducer are arranged in a common capsule housing.

14. The microphone arrangement of claim 1 where the plurality of pressure gradient transducers comprises four pressure gradient transducers and at least one of the pressure transducer and the four pressure gradient transducers are arranged on surfaces of a tetrahedron.

15. The microphone arrangement of claim 2 where the plurality of pressure gradient transducers comprises four pressure gradient transducers and at least one of the pressure transducer and the four pressure gradient transducers are arranged on surfaces of a tetrahedron, and at least one pressure transducer is positioned within the tetrahedron.

16. The microphone arrangement of claim 15 further comprising a plurality of pressure transducers being arranged on the surfaces of or within the tetrahedron.

17. The microphone arrangement of claim 1 further comprising a plurality of pressure transducers arranged on a plurality of surfaces of a tetrahedron.

18. A method of synthesizing one or more microphone signals from a microphone arrangement comprising:
providing a plurality of pressure gradient transducers, each having a diaphragm, a first sound inlet opening leading to the front of the diaphragm, and a second sound inlet opening leading to the back of the diaphragm;
providing a directional characteristic of each of the plurality of pressure gradient transducer having a direction of maximum sensitivity in a plurality of main directions, and in which the plurality of main directions of the plurality of pressure gradient transducers are inclined relative to each other,
providing a pressure transducer having an acoustic center lying within an imaginary sphere with a plurality of acoustic centers of the pressure gradient transducers, the imaginary sphere having a radius corresponding to double the largest dimension of the diaphragm of the plurality of pressure gradient transducer or the pressure transducer; and
summing up signals originating from a plurality of pressure transducers; and
generating an omni-directional characteristic from the output of the plurality of pressure transducers;
where the omni-directional characteristic is obtained by subtracting of sum of signals originating from the plurality of pressure gradient transducers from the sum of signals originating from the plurality of pressure transducers.

19. The method of claim 18 further comprising filtering the signals originating from the pressure gradient transducers before generating the omni-directional characteristic.

20. The method of claim 18 further comprising amplifying the that the signals originating from a plurality of pressure transducers before generating the omni-directional characteristic.
